(19) United States
(12) Patent Application Publication
(10) Pub. No.: US 2021/0314686 A1
(43) Pub. Date: Oct. 7, 2021

(54) MICROPHONE ARRANGEMENT

(71) Applicant: Harman International Industries, Incorporated, Stamford, CT (US)

(72) Inventor: Flórián Czinege, Budapest (HU)

(73) Assignee: Harman International Industries, Incorporated, Stamford, CT (US)

(21) Appl. No.: 17/223,397

(22) Filed: Apr. 6, 2021

(30) Foreign Application Priority Data
Apr. 7, 2020 (EP) 20168427.1

(51) Int. Cl. H04R 1/02; H04R 1/08

(52) U.S. Cl. CPC H04R 1/021; H04R 2201/021; H04R 2499/13; H04R 1/086

(57) ABSTRACT

A microphone arrangement includes a carrier structure having a rear surface, a front surface and a through-hole between the rear surface and the front surface, and a microphone having an enclosure, the enclosure comprising a rear section that fits into the through-hole and a front section that seats on the front surface of the carrier structure around the through-hole, the front section of the microphone enclosure has a front surface and a rear surface. A microphone cover layer covers the front surface of the front section of the microphone enclosure.

### CROSS REFERENCE

Priority is claimed to application serial no. 20168427.1, filed Apr. 7, 2020 in Europe, the disclosure of which is incorporated in its entirety by reference.

### TECHNICAL FIELD

The disclosure relates to a microphone arrangement.

### BACKGROUND OF INVENTION

For example in vehicles, microphones are placed in the passenger room at various places and are fixed to different components of the vehicle such as headlining surfaces, consoles, dashboard elements, or any other compartment components. The microphones can be disposed in front of, behind, as well as in planar or softly curved surfaces of such components. A main aspect of a microphone installation is that it should have the best acoustical behavior possible, but further aspects, including assembly, safety, reliability, and aesthetics, often have to be considered as well. Fulfilling these additional requirements including a vehicle's interior appearance, while achieving the desired acoustical behavior, is challenging.

### SUMMARY

A microphone arrangement includes a carrier structure that has a rear surface, a front surface and a through-hole between the rear surface and the front surfaces, and includes a microphone having an enclosure, the enclosure comprising a rear section that fits into the through-hole and a front section that rests on the front surface of the carrier structure around the through-hole. The front section of the microphone enclosure has a front surface and a rear surface. A microphone cover layer covers the front surface of the front section of the microphone enclosure.

### BRIEF DESCRIPTION OF THE DRAWINGS

The arrangement may be better understood with reference to the following drawings and description. The components in the figures (FIGS.) are not necessarily to scale: emphasis instead is placed upon illustrating the principles of the invention. Moreover, in the figures, like reference numerals designate corresponding parts throughout the different views.

FIG. 1. is a schematic cross-sectional view of a first example microphone arrangement with a microphone disposed in and attached to a carrier structure, in which a microphone cover layer covers a front surface of a front section of a microphone enclosure;

FIG. 2. is a schematic cross-sectional view of a second example microphone arrangement in which the microphone cover layer extends from a front surface to a rear surface of the front section of the microphone enclosure to be sandwiched between a rear surface of a front section of a microphone enclosure and a front surface of the carrier structure;

FIG. 3. is a schematic cross-sectional view of a third example microphone arrangement having a ring-shaped interior retainer frame disposed between the rear surface of the front section of the microphone enclosure, the rear section of the microphone enclosure and the carrier structure around the through-hole;

FIG. 4. is a schematic cross-sectional view of a fourth example microphone arrangement having a ring-shaped exterior retainer frame disposed on and around the microphone cover layer;

FIG. 5. is a schematic cross-sectional view of a first example microphone enclosure with a microphone cover layer that consists of or comprises acoustically permeable material; and

FIG. 6. is a schematic cross-sectional view of a second example microphone enclosure with a microphone cover layer that comprises openings, perforations and holes.

### DETAILED DESCRIPTION

A microphone is a device—a transducer—that converts sound into an electrical signal. Several types of microphones are used for this which employ different methods to convert the air pressure variations of the sound wave to the electrical signal. The most commonly used are the dynamic microphone, which uses a coil of wire suspended in a magnetic field; the condenser microphone, which uses the vibrating diaphragm as a capacitor plate; and the piezoelectric microphone, which uses a crystal of piezoelectric material. Other types such as ribbon, carbon, fiber-optic, laser, liquid, mmicro-electrical-mechanical system (MEMS) microphones etc. are also known. In all types of microphones, sound is first converted to mechanical motion by means of a diaphragm, the motion of which is then converted to an electrical (or optical) signal. A complete microphone also includes a housing and some connection means to transfer the signal from the transducer to other equipment such as an electronic circuit. A wireless microphone contains a radio transmitter.

The sound sensitive elements of a microphone are the primary source of differences in directivity. A pressure microphone uses a diaphragm between a fixed internal volume of air and the environment, and responds uniformly to pressure from all directions, so it is said to be omnidirectional. A pressure-gradient microphone uses a diaphragm that is at least partially open on both sides. The pressure difference between the two sides produces its directional characteristics. Other elements such as the external shape of the microphone and external devices such as interference tubes can also alter a microphone's directional response. A pure pressure-gradient microphone is equally sensitive to sounds arriving from front or back, but insensitive to sounds arriving from the side because sound arriving from the front and back at the same time creates no gradient between the two. The characteristic directional pattern of a pure pressure-gradient microphone is like a FIG. 8. Other polar patterns are derived by creating a capsule that combines these two effects in different ways. The cardioid, for instance, features a partially closed backside, making its response a combination of pressure and pressure-gradient characteristics. In the examples described below, the direction in which the microphone exhibits the highest sensitivity is referred to as the front (side, surface etc.) of the microphone.

An example microphone arrangement illustrated in FIG. 1 includes a carrier structure 101 with a rear surface 102, a front surface 103 and a through-hole 104 between the rear surface 102 and the front surface 103. The carrier structure 101 may be a headlining surface, console, dashboard, or any other compartment component. The arrangement further includes a microphone comprising an enclosure 105, wherein the enclosure 105 includes a rear section 106 that fits into the through-hole 104 and a front section 107 that seats on the front surface 103 of the carrier structure 101 around the through-hole 104. The front section 107 of the microphone enclosure 105 has a front surface 108 and a rear surface 109. A microphone cover layer 110 covers the front surface 108 of the front section 107 of the microphone enclosure 105. Optionally, the arrangement may further include a carrier cover layer 111 that covers the front surface 103 of the carrier structure 101.

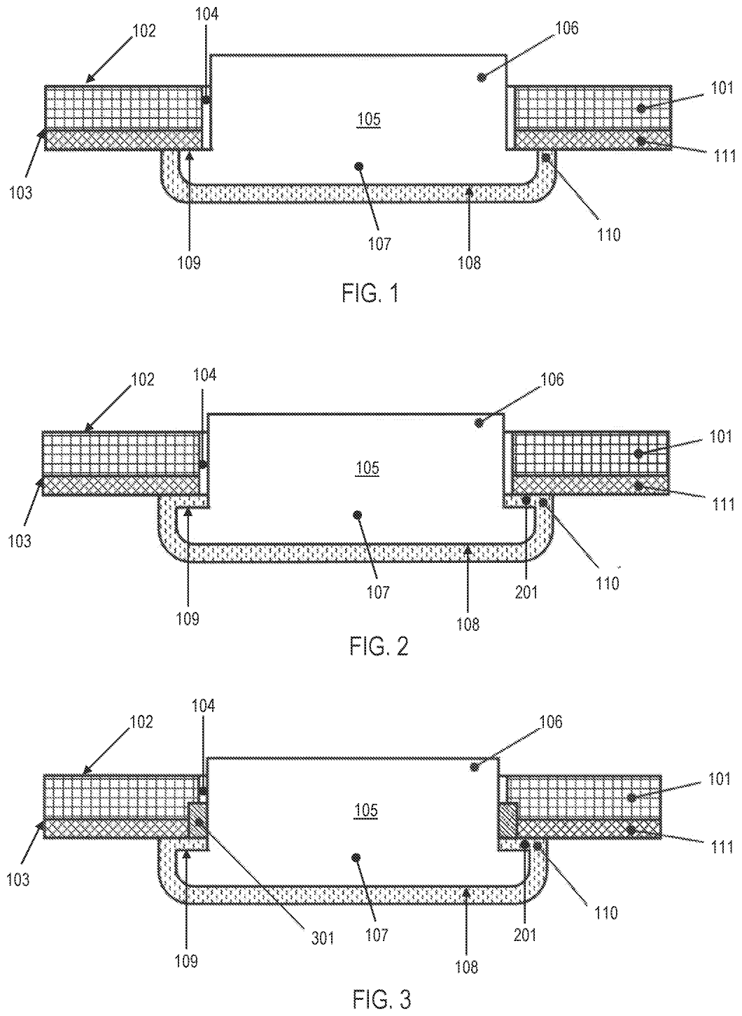

An example microphone arrangement illustrated in FIG. 2 is based on the arrangement shown in and discussed above in connection with FIG. 1, with the modification that the microphone cover layer 110 extends from the front surface 108 to the rear surface 109 of the front section 107 of the microphone enclosure 105 and that a thereby arising extension 201 of the microphone cover layer 110 is sandwiched between the rear surface 109 of the front section 107 of the microphone enclosure 105 and the front surface 103 of the carrier structure 101. If a carrier cover layer 111 covers the front surface 103 of the carrier structure 101, as shown in FIG. 2, the extension 201 of the microphone cover layer 110 is sandwiched between the rear surface 109 of the front section 107 of the microphone enclosure 105 and the carrier cover layer 111.

An example microphone arrangement illustrated in FIG. 3 is based on the arrangement shown in and discussed above in connection with FIG. 2 with the modification that a ring-shaped interior retainer frame 301 is disposed between the rear section 109 of the front section 107 of the microphone enclosure 105, the rear section of the microphone enclosure 105 and the carrier structure 101 adjacent to the through-hole 104. The interior retainer frame 301 may be used to at least one of fasten the microphone enclosure 105 to the carrier structure 101 and to fasten the microphone cover layer 110 to the microphone enclosure 105.

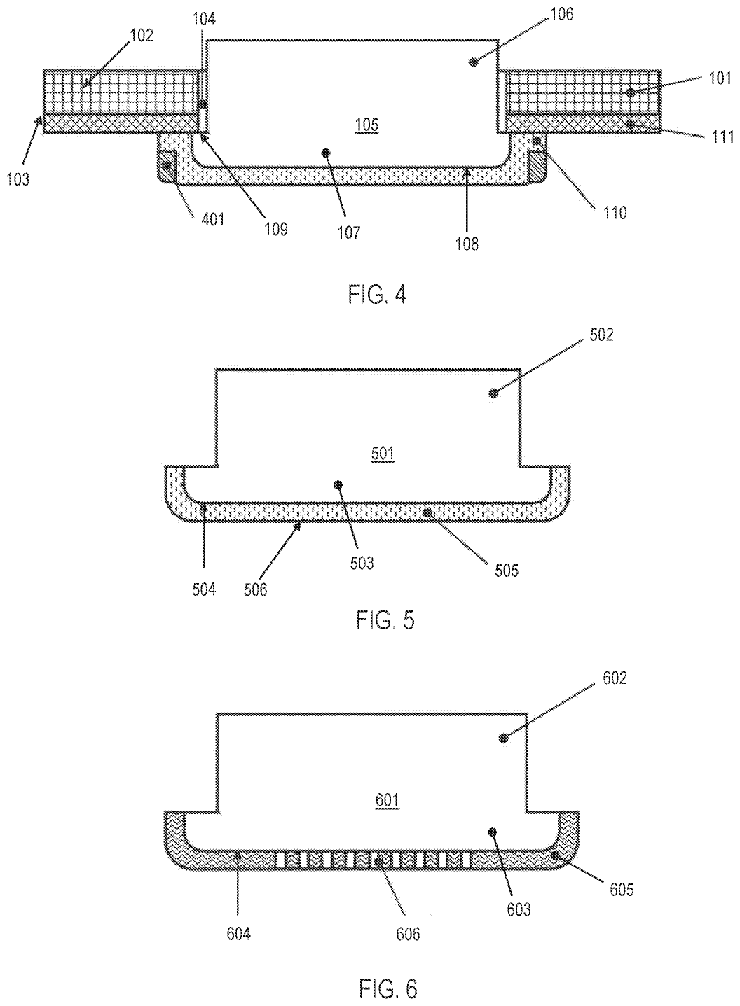

An example microphone arrangement illustrated in FIG. 4 is also based on the arrangement shown in and discussed above in connection with FIG. 2 with the modification that a ring-shaped exterior retainer frame 401 is disposed on and around the microphone cover layer 110. The exterior retainer frame 401 may be used to fasten the microphone cover layer 110 to the microphone enclosure 105.

FIG. 5 shows an example microphone enclosure 501 having a rear section 502 and a front section 503, wherein the front section 503 has a front surface 504 that is covered by a microphone cover layer 505. The microphone cover layer 505 consists of or comprises acoustically permeable material 506 such as, for example, foam, micro grids and fabric.

FIG. 6 shows an example microphone enclosure 601 having a rear section 602 and a front section 603, wherein the front section 603 has a front surface 604 that is covered by a microphone cover layer 605. The microphone cover layer 605 includes openings, perforations or holes 606.

The microphone cover layer may consist of or include at least one of natural leather, synthetic leather, semi-synthetic leather, textile, plastic and elastomer. The microphone cover layer is fixed to the microphone enclosure by at least one of gluing, adhering and molding. The front section of the microphone enclosure comprises edges, of which at least one edge may be curved (as shown in FIGS. 1-6) or faceted.

The surface of the microphone cover layer may be in conformity with the visual surface of the carrier structure in view of aesthetic, visual, softness, contact and tactile requirements. For example, these surfaces may be made of the same material. As already mentioned above, the visual surface can be made of a material that naturally has an acoustically permeable behavior, so that the acoustical energy can be transferred unaltered from the ambiance to the microphone. Alternatively, or additionally, the microphone cover layer may be provided with sound paths such as, for example, openings, cut-outs, holes or any surface modifications that create an acoustical channel from the ambiance to the microphone.

The microphone arrangements described above in connection with FIGS. 1-6 allow easily adapting a microphone arrangement to aesthetic requirements without compromising the acoustic performance of the microphones.

While various embodiments of the invention have been described, it will be apparent to those of ordinary skilled in the art that many more embodiments and implementations are possible. In particular, the skilled person will recognize the interchangeability of various features from different embodiments. As used in this application, an element recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” and “third,” etc. are used merely as labels, and are not intended to impose numerical requirements or a particular positional order on their objects.

1. A microphone arrangement comprising:
a carrier structure having a rear surface, a front surface and a through-hole between the rear surface and the front surface;
a microphone having an enclosure, the enclosure comprising a rear section that fits into the through-hole and a front section that rests on the front surface of the carrier structure around the through-hole, the front section of the microphone enclosure has a front surface and a rear surface; and
a microphone cover layer that covers the front surface of the front section of the microphone enclosure,

2. The arrangement of claim 1, wherein the microphone cover layer extends from the front surface to the rear surface of the front section of the microphone enclosure and is sandwiched between the rear surface of the front section of the microphone enclosure and the front surface of the carrier structure.

3. The arrangement of claim 1, further comprising a ring-shaped interior retainer frame disposed between the rear surface of the front section of the microphone enclosure, the rear section of the microphone enclosure and the carrier structure adjacent to the through-hole.

4. The arrangement of claim 1, further comprising a ring-shaped exterior retainer frame disposed on the microphone cover layer or around the microphone cover layer or both.

5. The arrangement of claim 1, wherein the microphone cover layer consists of or comprises acoustically permeable material.

6. The arrangement of claim 1, wherein the microphone cover layer further comprises openings, perforations, or holes.

7. The arrangement of claim 1, wherein the microphone cover layer consists of or comprises at least one of natural leather, synthetic leather, semi-synthetic leather, textile, plastic, and elastomer.

8. The arrangement of claim 1, wherein the microphone cover layer is fixed to the microphone enclosure by at least one of gluing, adhering, and molding.

9. The arrangement of claim 1, wherein the front section of the microphone enclosure comprises edges, of which at least one edge is curved or faceted.

10. The arrangement of claim 1, further comprising a carrier cover layer that covers the front surface of the carrier structure.

11. A microphone arrangement comprising:
a carrier structure having a rear surface, a front surface and a through-hole between the rear surface and the front surface;
a microphone having an enclosure, the enclosure having a rear section that fits into the through-hole and a front section that rests on the front surface of the earner structure around the through-hole, the front section of the microphone enclosure comprising a front surface and a rear surface; and
a microphone cover layer that covers the front surface of the front section of the microphone enclosure, the microphone cover layer extends from the front surface to the rear surface of the front section of the microphone enclosure and is sandwiched between the rear surface of the front section of the microphone enclosure and the front surface of the carrier structure.

12. The arrangement of claim 11, further comprising a ring-shaped interior retainer frame disposed between the rear surface of the front section of the microphone enclosure, the rear section of the microphone enclosure and the carrier structure adjacent to the through-hole.

13. The arrangement of any of claim 11, further comprising a ring-shaped exterior retainer frame disposed on the microphone cover layer or around the microphone cover layer or both.

14. The arrangement of claim 11, wherein the microphone cover layer consists of or comprises acoustically permeable material.

15. The arrangement of claim 11, wherein the microphone cover layer further comprises openings, perforations, or holes.

16. The arrangement of claim 11, wherein the microphone cover layer consists of or comprises at least one of natural leather, synthetic leather, semi-synthetic leather, textile, plastic, and elastomer.

17. The arrangement of claim 11, wherein the microphone cover layer is fixed to the microphone enclosure by at least one of gluing, adhering, and molding.

18. The arrangement of claim 11, wherein the front section of the microphone enclosure comprises edges, of which at least one edge is curved or faceted.

19. The arrangement of claim 11, further comprising a carrier cover layer that covers the front surface of the carrier structure.
